(19) United States
(12) Patent Application Publication
(10) Pub. No.: US 2026/0253422 A1
(43) Pub. Date: Aug. 27, 2026

(54) VEHICLE TRACKING VIA SESSIONS FOR MANAGED FACILITIES

(71) Applicant: Metropolis IP Holdings, LLC, Santa Monica, CA (US)

(72) Inventors: Ji Sung Hwang, Albany, CA (US); Daniel Bercht, Marina del Rey, CA (US); Barry James O'Brien, Seattle, WA (US)

(21) Appl. No.: 19/065,680

(22) Filed: Feb. 27, 2025

(51) Int. Cl. G06V 20/54; G06T 7/20; G06V 10/74; G06V 20/40; H04N 23/90

(52) U.S. Cl. CPC G06V 20/54; G06T 7/20; G06V 10/761; G06V 20/44; H04N 23/90; G06V 2201/07

(57) ABSTRACT

A system or method for managing and tracking vehicle movements within a managed facility. The system captures a first image of a vehicle by a first camera at a first location, associates the first image with a first event identifier, and applies a vehicle identification model to determine an identification of the vehicle. Similarly, a second image is captured by a second camera as the vehicle continues through the facility, linked to a second event identifier. In response to determining that both images are identified as a same vehicle, both events are associated with a single session. The system then constructs a session timeline based on these events.

### TECHNICAL FIELD

The disclosure generally relates to machine learning and computer vision, and more particularly relates to using advance machine learning and computer vision techniques for sophisticated vehicle tracking via sessions for managed facilities.

### BACKGROUND

In traditional vehicle tracking systems, the monitoring of activity within a managed facility (e.g., entry/exit events, infraction events, etc.) is limited to isolated activity. For example, within a managed facility, vehicle exit and entry events are often determined in isolation of other activity of the vehicle within the managed facility (e.g., only at entry and exit gates based on the entry and exit activity in isolation). Following this example, an entry event is typically recorded when a vehicle passes a certain point, like entering through a gate, where a camera or sensor logs the vent by capturing the vehicle's license plate or triggering a motion sensor. Similarly, an exit event is logged when a vehicle passes through a designated exit point, against triggering sensors or cameras which note the time and possibly the license plate.

Reliance solely on events in isolation results in data sets that are not robust. Following from the earlier example, if the vehicle's entry or exit does not trigger the sensor as expected (e.g., due to the vehicle's speed, angle, or sensor malfunction), the event may not be recorded. Because the data collection is tied to specific trigger points, any activity that does not conform to expected patterns (like backing out of a lane or stopping and then proceeding) might not be captured or properly logged. If a vehicle enters a detection zone but then reverses direction and exits the same way it enters (without triggering an exit sensor), it could be missed or incorrectly logged as still being inside the zone. Vehicles that enter but do not exit as anticipated (perhaps due to parking and leaving the vehicle for an extended period) might not be tracked continuously. The system might lose track of such vehicles, especially if the sensors are only at entry/exit points.

These issues lead to incomplete data where a vehicle in a managed area is not accurately or fully recorded. This can result in discrepancies in data reports, such as overstating or understating the number of vehicles present, failing to capture infractions or identify vehicles causing infractions, and so on. Facilities with compliance requirements for vehicle tracking could face penalties or operational challenges due to inaccurate data logs. Inaccurate tracking can also pose security risks, as unauthorized or unrecorded entries.

### SUMMARY

Embodiments described herein address the above-describe limitations by using advanced machine learning and computer vision techniques to capture an event stream including a sequence of events at different points in a managed facility. This event stream is a continuous flow of hardware-detected events, machine learning detected events, and/or matching events, providing a form of “ground truth” or “digital twin” that represents a real time state of the managed facility. The event stream enables a system to perform analysis to derive insights from partial observations, repeated activity patterns, or diverse interactions. For example, these events may be organized into sessions based on various criteria, such as vehicle identifiers, user identifiers, time intervals, event-capturing device identifiers, zones, and/or a combination thereof.

In some embodiments, a system captures a first image of a vehicle as the vehicle traverses a field of view of a first camera at a first location within the managed facility and associates the first image of the vehicle with a first event. The system applies a vehicle identification model to the first image to determine an identification of the vehicle. The system captures a second image of the vehicle as the vehicle traverses a field of view of a second camera at a second location within the managed facility and associates the second image of the vehicle with a second event. The system applies the vehicle identification model to the second image to determine an identification of the vehicle. In response to determining the first event and the second event are associated with a same identifier of the vehicle, the system associates the first event and the second event with a same session identifier and determines a session timeline of the vehicle based on a sequence of events.

In some embodiments, the first image and the second image are stored in a data repository tagged with a respective event identifier and a session identifier. In some embodiments, a speed and direction of the vehicle and/or other metadata associated with the event-detecting devices are also determined and stored with the respective events. In some embodiments, sessions may be generated based on other criteria, which may or may not include vehicle identification.

As such, the system utilizes combinations of various computer vision and machine learning technologies to enhance accuracy in vehicle identification, and improve overall security measures in managed facilities.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates an example system environment for managing vehicle parking or transit through a managed facility, in accordance with one or more embodiments.

FIG. 2 illustrates an example architecture of an edge device 110, in accordance with one or more embodiments.

FIG. 3 illustrates an example architecture of the vehicle management server 130, in accordance with one or more embodiments.

FIG. 4 is a flowchart of an example method for tracking vehicle sessions in managed facilities, in accordance with one or more embodiments.

FIG. 5 is a flowchart of an example method for organizing vehicle events within a managed facility into sessions, in accordance with one or more embodiments.

FIG. 6A-6C depict an exemplary managed facility vicinity and moveable gate in accordance with one or more embodiments.

FIG. 7 is a block diagram illustrating components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Traditional vehicle tracking systems in managed facilities such as parking structures generally log vehicles as they enter, exit, or navigate through a facility, the utilizing cameras or sensors to capture discrete events like recording license plates or motion detection. Events recorded by various sensors can become fragmented, making it difficult to piece together a coherent timeline for each user or vehicle. In environments like parking structures or other logistic operations, accurately tracking the entry, movement, and exit of vehicles can be challenging.

Further, systems can experience anomalies like tailgating, incorrect sensor activations, when vehicles enter but then reverse direction without activating the expected exit sensors, or due to other activities that deviate from the usual patterns, such as infractions. Such anomalies can lead to operational challenges, compliance issues, and may inaccurately reflect vehicle counts, thereby posing potential security risks from untracked vehicle movements.

When an exit event occurs, the system may attempt to match it with a corresponding entry event or other navigational events for the same vehicle. However, inaccuracies in vehicle or license plate identification can prevent successful matching, resulting in what are known as “hanging events.” These hanging events may need to be reviewed by human operators later, resulting in operational inefficiencies.

The embodiments described herein leverage advanced computer vision and machine learning technologies to address the limitations of traditional vehicle tracking systems by capturing a stream of events, which represents a “ground truth” or a “digital twin” of activities in the managed facility. The event stream is generated by continuously capturing, processing, and aggregating data from multiple sources within a managed facility. The sources within the managed facility may include hardware devices, such as gate controls, cameras, proximity sensors, and other edge devices. Some of these hardware devices may be configured to detect events and generate sensing data, while others may be configured to transmit sensing data to the cloud computing system, which, in turn, processes the sensing data to detect events.

In some embodiments, these events may be organized into sessions based on various criteria, such as vehicle identifiers, user identifiers, time intervals, device identifiers, zones, and/or a combination thereof. For example, a vehicle-identifier based session includes all events associated with a same vehicle. An hourly session includes all events occurring within a particular hour, while a daily session includes events from an entire day. A device-based session includes all events recorded by the same device, and a user-identifier-based session gathers events related to vehicles associated with the same user account.

In some embodiments, sessions can be generated dynamically in response to queries from a user's client device. For instance, a query may specify a start time and end time, prompting the system to retrieve events occurring within that time frame. A query might also include additional criteria, such as a vehicle identifier or a user identifier, along with the time range. In response, the system identifies and retrieves events linked to the specified vehicle or user during the given period.

In some embodiments, the system can identify events associated with same vehicles and link them into a session, instead of treating entry, exit, and other events as isolated instances, as is typical in traditional systems. In response to detecting an entry event in the event stream, the system initiates a new session, which links all subsequent events in the stream involving the vehicle to this session until an exit event is recorded.

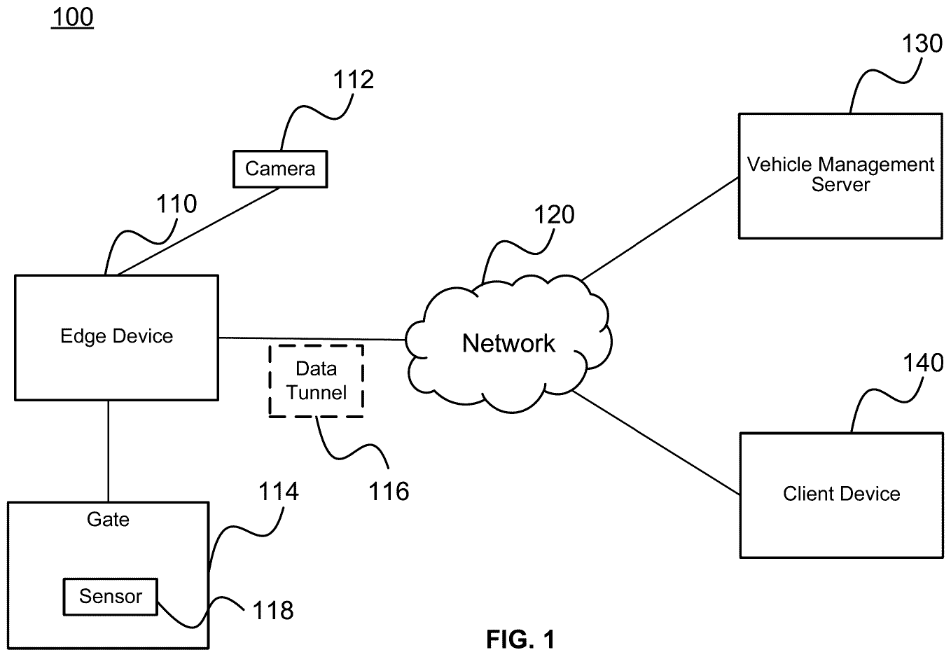

Using sessions in an event stream to track entry and exit events of same vehicles is merely one example use case. The event stream can also be utilized in other downstream applications to enhance decision-making and enable real-time responses to operational challenges, such as handling anomalies and/or partial matching data. Additional details about generating an event stream and using the event stream to manage vehicles in a managed facility are further described below with respect to FIGS. 1-7.

### Configuration Overview

FIG. 1 illustrates an example system environment 100 for managing vehicle parking or transit through a managed facility, in accordance with one or more embodiments. A managed facility is referred to any environment or area where access may be monitored and/or regulated. These facilities may include parking garages, car wash, corporate campuses, hospitals, logistics and distribution centers, university campuses, gated communities, airports, shopping centers, among others.

The environment 100 includes one or more edge devices 110, one or more cameras 112, one or more gates 114, data tunnels 116, and sensors 118, one or more client devices 140, the vehicle management server 130, and a network 120. While only one of each feature of environment is depicted, this is for convenience only, and any number of each feature may be present. Where a singular article is used to address these features (e.g., “camera 112”), scenarios where multiples of those features are referenced are within the scope of what is disclosed (e.g., a reference to “camera 112” may mean that multiple cameras are involved). For example, a first camera 112 and a first edge device 110 may be located at an entry of the managed facility, a second camera 112 and a second edge device 110 may be locate at an exit of the managed facility, and additional cameras 112 and edge devices 110 may be located at intersections within the managed facility.

The network may include (but is not limited to) the internet, local area network (LAN), wireless local area network (WLAN), or cellular networks (such as 2G, 3G, 4G, 5G, 6G, among others), wireless personal area network (WPAN), enabling data exchange between the edge devices 110, the vehicle management server 130, and client devices 140.

Gates 114 are physical or logical barriers that control vehicle entry and exit at the managed facility. The cameras 112 are configured to capture images and videos of vehicles from various angles and locations in the managed facility. The sensors 118 work alongside the cameras to detect various conditions at the managed facility, such as vehicle presence, speed, direction, and/or infractions, among others.

Edge devices 110 may be coupled to cameras 112, sensors 118, and/or gates 114, and configured to receive and process images and sensing data generated by the cameras and/or sensors to detect events, such as vehicle entry, vehicle exit, vehicle approaching, leaving, vehicle speed, and/or infractions. In some embodiments, edge devices 110 are also configured to apply pre-trained machine-learning models to received images and sensing data to detect events and identify vehicles. Alternatively, vehicle identification may be performed by the vehicle management server 130. For example, edge devices 110 may send vehicle-related data to the vehicle management server 130 for further processing (e.g., vehicle identification) and receive the processed data (e.g., identifier of the vehicle) from the vehicle management server 130.

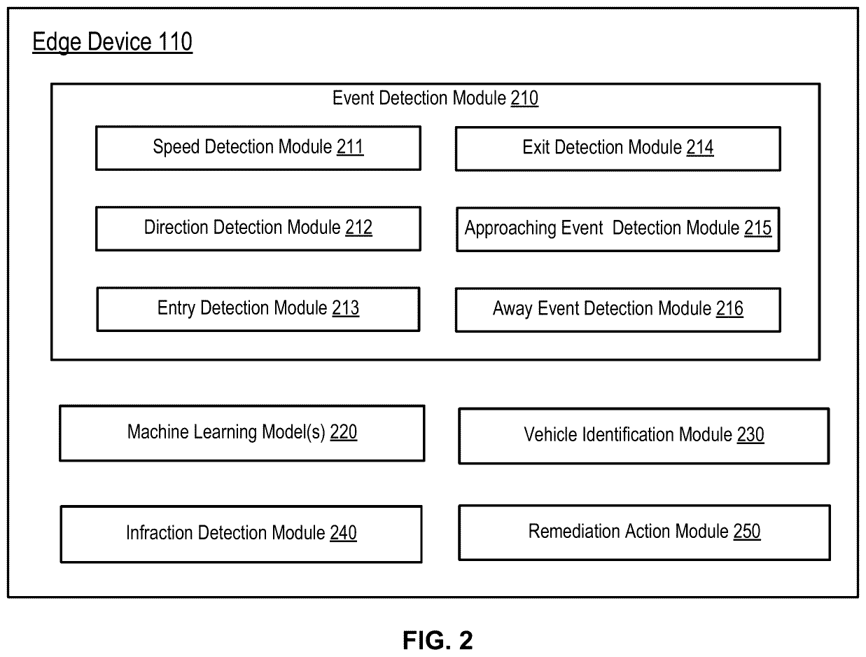

Additionally, in some embodiments, the edge devices 110 can make real-time decisions based on the output of the machine learning models or processed data received from the vehicle management server 130, such as determining whether an identified vehicle is authorized to enter the managed facility. In response to determining that the identified vehicle is authorized to enter the managed facility, edge devices cause a gate 114 to open. Additional details about edge devices 110 are further described below with respect to FIG. 2.

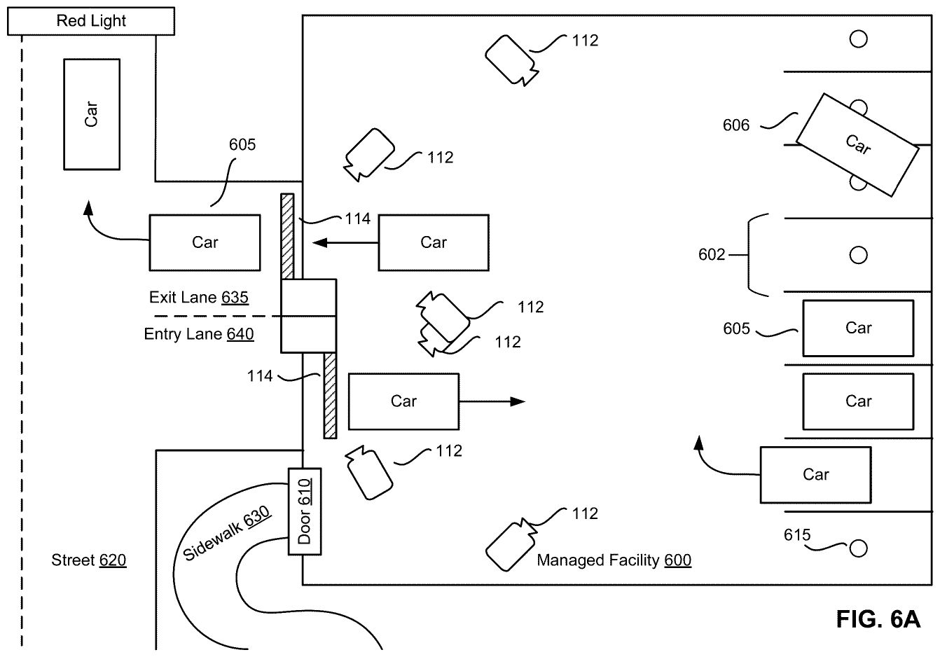

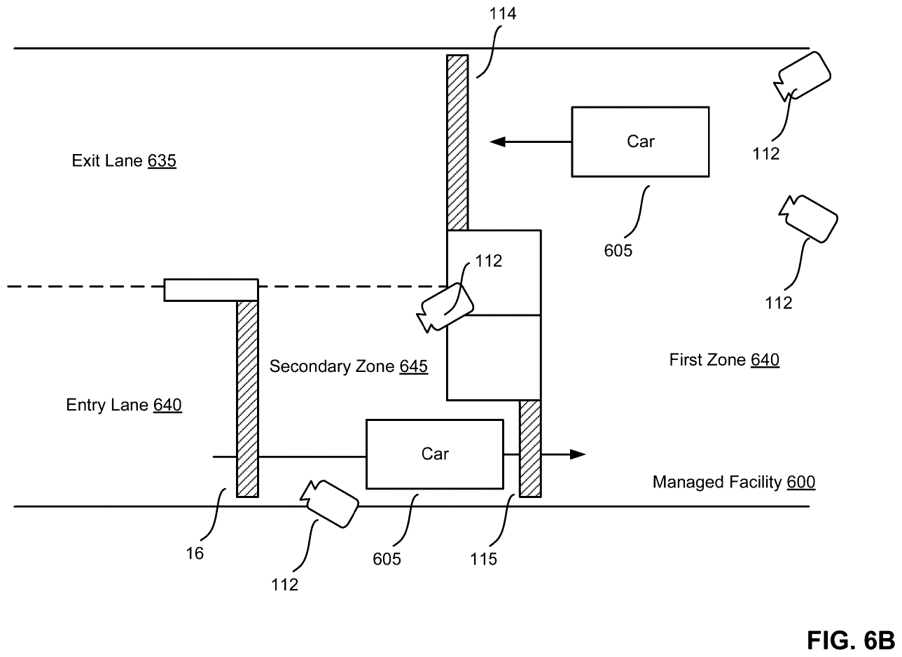

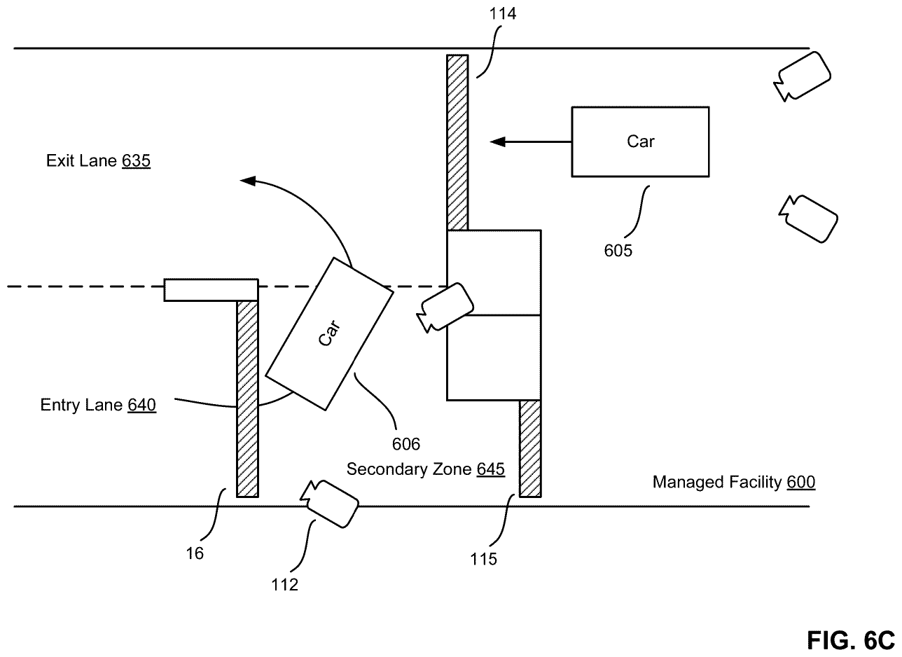

In a managed facility, edge devices 110, cameras 112, and/or sensors 118 are strategically positioned to maximize coverage and functionality. These devices are typically installed near key access points, such as vehicle entry and exit gates, junctions, boundaries between different zones, high traffic areas, loading docks, pedestrian entry points, among others. Cameras may be mounted in locations that offer wide, unobstructed view of these areas to capture clear images and videos of vehicles as they enter, exit, and navigate the facility. Additional details related to a managed facility are further described below with respect to FIGS. 6A-6C.

The vehicle management server 130 receives data from the edge devices 110, including vehicle images and sensing data. As described above, in some embodiments, the edge devices 110 may be configured to identify vehicles and events. These identified vehicles and events are transmitted to the vehicle management server 130 for storage or further processing. Alternatively, the vehicle management server 130 is configured to perform vehicle identification.

Further, the vehicle management server 130 is also better suited for perform more complex and larger scale processing, such as data storage, profile updates, session management, and possibly retraining machine learning models based on newly acquired data. This is because the server 130 is generally equipped with more powerful processors and greater memory capacity than local devices, such as cameras 112 and edge devices 110. The vehicle management server 130 can also act as central repository for data collected from multiple sources across multiple facilities. This centralized data management makes it more efficient to perform comprehensive analysis, run complex queries, and generate detailed reports that would be too resource-intensive for edge devices 110. The server 130 also provides the infrastructure to scale up operations without degrading performance. As the amount of data or the number of devices increases, servers can be upgraded or added to handle this increase more effectively than trying to upgrade many individual edge devices.

In some embodiments, the vehicle management server 130 receives images of the same vehicle captured by different cameras at different locations within the managed facility as the vehicle enters, navigates, and exits the facility. As described above, these images and sensing data are associated with events, such as entry, exit, navigation, parking, infraction, etc. The vehicle management server 130 receives and records these events continuously to generate an event stream. The event stream represents a “ground truth” or a “digital twin” of activities in the managed facility. The event stream may be organized into sessions based on various criteria.

In some embodiments, the criteria are based on vehicle identifier, and the vehicle management server 130 processes these events in the stream to determine whether they belong to a same vehicle. In response to determining that they belong to the same vehicle, the vehicle management server 130 associates these events with a single session identifier and determines a session timeline of the vehicle based on the sequence of events, such as an entry event, a navigation event, a parking event, an exit event, among others. The data associated with the same session is stored together relationally.

In some embodiments, the session association is also based on the speeds of the vehicle, directions of the vehicle, timestamps of each event, among others. The speed, directions of the vehicle, and timestamps captured when a vehicle moves through different parts of the facility can help in correlating events captured at various points. For instance, speed data can indicate driving habits. A first event associated with an unusually fast speed and a second event associated with an unusually slow speed may be used to infer that these two events may not be associated with the same driver, thus not the same session. Further, analyzing the direction in which a vehicle is traveling and timestamps at different points can also help associate events with sessions. For example, if an event associated with the vehicle indicates that the vehicle enters a second zone from a first zone, a subsequent event captured in the first zone is likely not to belong to the same vehicle.

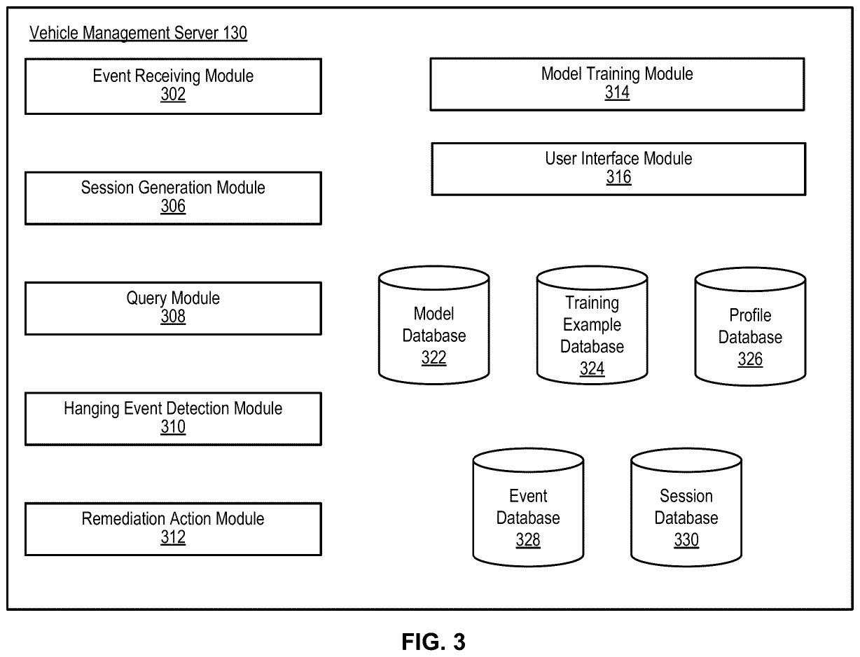

In some embodiments, the vehicle management server 130 can also provide a graphical user interface to users, such as drivers or facility managers. Additional details about the vehicle management server 130 are further described below with respect to FIG. 3.

Client devices 140 may be devices associated with drivers and/or facility managers, such as mobile devices, personal computers, among others. Client devices 140 may include a user agent (e.g., a browser or a mobile app), which allows a user to interact with the vehicle management server 130. For example, a driver may be able to see sessions associated with their vehicle via a driver mobile app. A facility manager may be able to see reports related to their managed facility, such as a total number of vehicles inside the facility and their identifiers via a management portal.

FIG. 2 illustrates an example architecture of an edge device 110, in accordance with one or more embodiments. The edge device 110 includes an event detection module 210, one or more machine learning models 220, a vehicle identification module 230, an infraction detection module 240, and a remediation action module 250. The modules listed in FIG. 2 are illustrative examples, and depending on the type of devices and the functions desired by the managed facility, additional or fewer modules may be implemented in an edge device 110. Modules within the edge device 110 can be configured flexibly: multiple modules may be combined into one to perform a range of functions, or a single module might be split into several, with each handling a specific subset of tasks.

The event detection module 210 is configure to detect various events. In some embodiments, the event detection module 210 includes multiple submodules. These submodules includes a speed detection module 211, a direction detection module 212, an entry detection module 213, an exit detection module 214, an approaching event detection module 215, an away event detection module 216, and an infraction detection module 240. Notably, the submodules listed here are also illustrative examples, additional or fewer submodules may be implemented in an event detection module 210 of an edge device. For example, an edge device 110 coupled to a parking sensor may be a single function sensor configured to detect parking events. An edge device 110 coupled to a camera may be able to detect a variety of events, including infraction events.

The speed detection module 211 is configured to determine a speed of a vehicle within the managed facility. In some embodiments, the speed detection module 211 uses images captured by the cameras and/or sensing data generated by the sensors to determine the speed at which vehicles travel through different points within the facility. The direction detection module 212 is configured to detect a directional movement of vehicles, such as approaching a camera or sensor or away from the camera or sensor. In some embodiments, the direction of the vehicle may be determined by analyzing the sequence of images captured by the camera.

The entry detection module 213 is configured to monitor and detect when vehicles enter the facility. In some embodiments, the entry detection module 213 uses cameras or sensors placed at entry points to detect and register each vehicle as it enters the facility. Similarly, the exit detection module 214 is configured to monitor and detect when vehicles leave the facility. In some embodiments, the exit detection module 214 also uses cameras or sensors placed at exit points to detect and register each vehicle as it leaves the facility. Entry and exit events are special events because when an entry event is detected, a new session is generated. Subsequent events detected will be associated with this new session. Conversely, when an exit event is detected, the session is closed. Once the session is closed, no new events can be associated with the session. For instance, when a vehicle leaves the facility, its current session is closed, and in response to re-entering the facility, a new session is initiated for that vehicle.

The approaching event detection module 215 is configured to detect vehicles as they approach a camera or sensor within the managed facility. In some embodiments, when a vehicle approaches a sensor, it may trigger a motion detector, break a light beam, or be detected by other proximity sensors that activate the camera. The camera, once activated, captures images or video. Image recognition models analyze the frames to detect movement towards the sensor. The models can differentiate between approaching and receding movements based on the change in size and orientation of the vehicle image within the frame. As the vehicle approaches the camera or sensor, the vehicle size in the images increases, and the approaching event detection module 215 determines the movement direction approaching the camera or sensor.

The away event detection module 216 is configured to detect vehicles as they move away from the camera or sensor within the managed facility. Similar to the approach detection, away events can be triggered by the vehicle breaking a sensor connection, such as moving out of a light beam or reducing motion detected by motion sensors. The camera, once activated, captures the vehicle moving away, and image recognition models analyze the sequence of images. As the vehicle moves away, its image size decreases, and the models determine this movement direction away from the camera or sensor.

Pretrained machine learning models 220 may be deployed onto the edge device 110 for vehicle detections, event detections, and vehicle identifications, among others. The vehicle identification module 230 is configured to identify vehicles based on data captured by cameras within the managed facility. In some embodiments, the vehicle identification module 230 applies various machine learning models 220 to process the images to identify vehicles' make, model, color, license plate, and/or other features, and these identified features are then used to identify the vehicles.

The infraction detection module 240 is configured to identify violations caused by vehicles or facility users. Infractions might include damage to the facility's gates (e.g., bumping into or crashing through them), damage to other vehicles, unauthorized entry, speeding, improper use of parking spaces, or unauthorized presence during restricted hours (e.g., overnight stays). Additionally, user-related infractions can include vandalism or theft of vehicles. The detection is based on various sensor data such as from cameras, gate sensors, parking sensors, audio sensors, or speedometers.

For instance, gate sensors can detect if a gate remains ajar, suggesting it may have been struck, while audio sensors might pick up the sound of breaking glass, indicating a break-in. The infraction detection module 240 uses different sensors to ascertain different types of infractions. If multiple parking sensors indicate that spaces are occupied concurrently, it might suggest a single vehicle occupying multiple spaces, which can then be verified using camera data.

Moreover, the infraction detection module 240 can employ a combination of sensors to enhance detection accuracy. For example, combining audio detection of a break-in with visual confirmation from cameras. It can also control moveable camera systems, such as drones or cameras on tracks, directing them to the infraction site to gather precise visual evidence and potentially follow moving subjects. In some embodiments, the infraction detection module 240 may also be configured to record all infractions in an Infraction Database with detailed metadata, including timestamps.

In cases where infractions are user-related, events associated with the same session of the vehicle, such as entry event, and other navigation related events, may be retrieved. This comprehensive profiling aids in enforcing facility rules and ensuring security.

In some embodiments, images and/or sensing data of sessions associated with infractions are annotated with metadata describing the corresponding infraction. The images and/or sensing data can then be used as training data to train a machine learning model. The machine learning model is trained to receive a set of one or more images and/or sensing data associated with a vehicle in a session, and determine a likelihood that the vehicle has committed at least one of multiple infractions. In response to determining that the likelihood that the vehicle has committed an infraction is greater than a predetermined threshold, the infraction detection module 240 determines that an infraction has occurred. For example, the type of infractions that the machine learning model can detect may include (but are not limited to) speeding, parking violations, traffic flow violation (wrong-way driving), stop sign and traffic light violations, idle time excess, noise violations, tailgating, among others.

The remediation action module 250 is configured to initiate a predefined corrective action in response to detecting an infraction. These actions can be automated or may require human intervention, depending on the severity and nature of the infraction. For example, in some embodiments, the remediation action module 250 may issue fines or alerts, initiating physical barriers, or notifying facility management.

For instance, in response to detecting, by the infraction detection module 240, that a vehicle is speeding through the facility, the remediation action module 250 may retrieve the driver's identification from the system's database based on the vehicle identification. The remediation action module 250 can then automatically generate and send a push notification to the mobile app installed on the user's smartphone, alerting them to the infraction and advising them to reduce their speed. This immediate feedback mechanism not only serves to enhance compliance with facility speed limits but also reinforces safe driving practices within the premises.

Alternatively, or in addition, the remediation action module 250 may interact with the vehicle management server 130 to update vehicle profiles or modify access permissions based on the infractions.

FIG. 3 illustrates an example architecture of the vehicle management server 130, in accordance with one or more embodiments. The vehicle management server 130 includes a event receiving module 302, session generation module 306, query module 308, hanging event detection module 310, remediation module 312, model training module 314, and user interface module 316. The vehicle management server 130 also includes multiple databases, including model database 322, training example database 324, profile database 326, event database 328, and session database 330.

The event receiving module 302 is configured to receive, record, and organize events generated by hardware devices (e.g., camera 11, and sensor 118) and machine learning models (e.g., machine learning models 220 deployed on the edge device 110, or machine learning models stored in the model database 322) in real time or near real time. The received events are aggregated and recorded into an event stream, which represents a “ground truth” or a “digital twin” of the managed facility. Events in the stream may include events associated with vehicle entries, exits, and other sensor-triggered activities, occurred in a chronological sequence. The event stream is stored in the event database 328.

In some embodiments, the event stream may be stored in a time-ordered queue where each new event is appended to the end of the queue. In some embodiments, the event stream may be stored as rows in a relational database, with each row representing a single event and columns for event details, e.g., timestamp, event type, vehicle ID, and/or session ID.

It is advantageous to record the event stream for a number of reasons. First, the event stream provides a centralized view of all vehicle or lane activities in real-time, which can be used for downstream modules for analysis, such as detection of anomalies (e.g., unauthorized access, tailgating, or sensor malfunctions) and pattern recognitions in real time or near real time.

The events in the stream may be organized into sessions based on various criteria, such as vehicle identifiers, user identifiers, time intervals, event-capturing device identifiers, zones, and/or a combination thereof. In some embodiments, events associated with a same vehicle in the stream can be grouped into a session, which enables tracking of a vehicle's journey through different areas of the managed facility. Additionally, the system can utilize the event stream to derive insights from incomplete data. For example, even if a vehicle fails to generate an entry or exit event, the system can still analyze intermediate events to derive insights.

The session generation module 306 is configured to link related events based on criteria such as temporal proximity, vehicle identification, or location data. In some embodiments, sessions may be generated in response to user queries specifying criteria like time range, vehicle identifiers, or user identifiers. In some embodiments, sessions may be generated based on a sequence of related events, such as entry and exit events of a vehicle, and other events between the entry and exit event of the same vehicle.

In some embodiments, the session generation module 306 may generate sessions for vehicles based on their entry into and exit from the managed facility. In response to detecting an entry event, such as a vehicle entering a gate of the managed facility, the session generation module 306 initiates a new session. This session is a data structure that groups all subsequent events associated with the vehicle until an exit event is detected. In response to detecting that the vehicle exits the facility, the session generation module 306 closes the session, preventing any further events from being associated with it. The events within this session may be stored with a vehicle account or user account associated with the vehicle. The user may review their vehicle sessions via a mobile application or a web browser installed on a client device.

In some embodiments, the session generation module 306 generates sessions based on other criteria. For example, an infraction-based session may be triggered upon detecting an infraction event. When an infraction event is detected, the session generation module 306 may generate a session that includes a start time and an end time covering the infraction event and one or more other events occurring before and after the infraction event within a predetermined time frame, likely associated with the same vehicle. For instance, in response to detecting a tailgate event, the session generation module 306 may generate a session starting from the detection of the tailgate event to track the multiple vehicles that entered the managed facility together. Sessions associated with infractions may be sent to a client device of the facility manager for review, or send to a client device of a user associated with the vehicle as a notification or warning.

The query module 308 is configured to receive queries from users or a downstream application and search the event stream to generate a session including a sequence of related events, or identify existing sessions based on the queries. In some embodiments, the query module 308 receives a set of criteria provided by a user or a downstream application, such as time ranges, vehicle identifiers, user identifiers, or device identifiers, identifies a sequence of events in the stream that satisfy the set of criteria, and generates a session linking the sequence of events. The session can then be sent to the user for review or the downstream application for further processing.

The hanging event detection module 310 is configured to identify entry events that cannot be associated with any entry event or vice versa. In some embodiments, the hanging event detection module 310 identifies hanging events based on generated sessions. For example, a session including an entry event followed by an unreasonably long gap (e.g., a week, a month) without an exit event may indicate a hanging event. Similarly, a session including an exit event occurring without a preceding entry event may also be flagged.

The remediation action module 312 is configured to take corrective actions in response to infractions or anomalies detected in the event stream or associated sessions. In some embodiments, in response to receiving an infraction event in the event stream, the remediation action module 312 causes the session generation module 306 to generate a session associated with the detected infraction event to obtain additional context about the vehicle. For example, an infraction session associated with a tailgate event can provide details about all vehicles involved. The remediation action module 312 can identify the tailgating vehicle based on the additional events within the session. As another example, a remediation action module 312 may also use zone-based session to identify whether a vehicle has overstayed in a restricted zone. In response to identifying the infraction vehicles, the remediation action module 312 may issue an alert to a client device of a user associated with the vehicle, or a client device of a facility manager. Alternatively, or in addition, the remediation action module 312 may block the vehicle at an exit until the infraction or violation is resolved.

The model training module 314 is configured to train and/or retrain various machine learning models using the training examples stored in the training example database 324. The trained and/or retrained machine learning models are stored in the model database 322. These models may include (but are not limited to) subsequent/precedent event prediction model (trained to predict a most likely subsequent event or precedent event based on a given event), vehicle localization models (trained to determine a position and orientation of a vehicle in an image), vehicle identification models (trained to identify an vehicle in an image), license plate localization models (trained to determine a position and orientation of a license plate in an image), license plate identification models (trained to identify a license plate), other feature identification models trained to identify other features of a vehicle (e.g., model, make, sticker), which may further be used to in combination of the vehicle identification models and/or license plate identification models to identify vehicles.

The training examples may include labeled and/or annotated images. For training a model associated with vehicle localizations and identifications, each image in the training examples may include a bounding box around each vehicle in the image, and the bounding box may further be annotated with an identification of the vehicle. For training a model associated with license plate localizations and identifications, each image in the training example may include a bounding box around each license plate in the image. These models may be trained using a variety of machine learning techniques, including (but not limited to) decision trees, random forests, gradient boosting machines (GBM), neural networks, Markov chains, recurrent neural network (RNNs), long short-term memory (LSTM) networks, convolutional neural networks (CNNs), YOLO (You Only Look Once), SSD (single shot multibox detector), region-based CNNs (R-CNNs), transfer learning, data augmentation techniques, ensemble learning, feature pyramid networks (FPN), semantic segmentation, and neural architecture search (NAS).

In some embodiments, the models may be trained and retrained based on correction data. The correction data is generated from instances where the initial model outputs were incorrect and subsequently corrected either through manual review by human operators or automatically corrected using hanging events and session matching. The correction data may include images with bounding boxes annotated with correct labels. In some embodiments, in response to detecting a vehicle or a license plate, the models generate a bounding box and annotate the bounding box with the identified feature (e.g., an identifier of a vehicle, an identifier of a license plate). However, if the correction data indicates such identification was incorrect, a new training example may be generated based on this image with corrected feature.

Additional details about the training and retraining of machine learning models can be found in U.S. Non-Provisional application Ser. No. 18/806,295, filed on Aug. 15, 2024, which is hereby incorporated by reference in its entirety.

The profile database 326 is configured store information about each vehicle that has entered or exited the managed facility. Such information includes the vehicle's make, model, color, license plate number, and potentially other identifying characteristics, such as stickers, wheel designs, among others. The profile database 326 can also store historical sessions of each vehicle. In some embodiments, the server 130 may also support user profiles, and the profile database 326 may also include owner or driver information linked to each vehicle.

The event database 328 is configured to store records of various events detected within the managed facility. This may include (but is not limited to) data on vehicle entries, exits, parking events, infractions, and any other sensor-triggered events. For example, each record may contain information such as a time and date of the vent, the location within the facility where it occurred, and specifics about the vehicle involved, like its license plate or vehicle identification.

The session database 330 stores information related to sessions established for vehicles as they enter and navigate within the managed facility. The sessions may be generated based on various criteria, such as vehicle identifier or specific events (e.g., infraction events). In some embodiments, a session includes all related events from a vehicle's entry to its exit. In some embodiments, a session is associated with a infraction event. This session database 330 records details such as the session start time, end time, and any associated events like navigation, parking, and infractions detected between the start time and end time. The session database 330 also tracks the vehicle's movements and activities during its time within the facility, linking all actions to a specific session identifier.

### Example Method for Tracking and Managing Vehicles Sessions in Managed Facilities

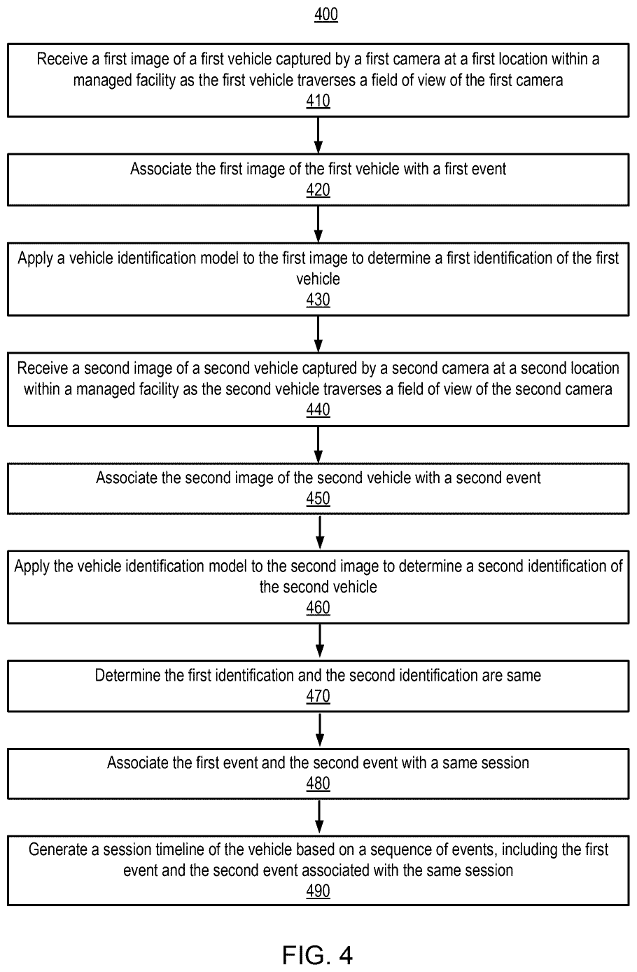

FIG. 4 is a flowchart of an example method for tracking vehicle sessions in managed facilities, in accordance with one or more embodiments. Alternative embodiments may include more, fewer, or different steps from those illustrated in FIG. 4, and the steps may be performed in a different order from that illustrated in FIG. 4. Method 400 may be executed by one or more processors of a system, which may include an edge device 110, a vehicle management server 130, and/or a client device 140. The one or more processors may include processor of edge device 110 and/or of vehicle management server 130 executing instructions that cause one or more modules to perform their respective operations.

The system receives 410 a first image of a first vehicle captured by a first camera at a first location within a managed facility as the first vehicle traverses a field of view of the first camera. The system associates 420 the first image of the first vehicle with a first event, and applies 430 a vehicle identification model to the first image to determine a first identification of the first vehicle. For example, the first camera may be located at an entry of the managed facility.

When the first vehicle enters into the managed facility, the first camera captures an image, a sequence of images, or a video of the first vehicle, and an entry event is detected. In some embodiments, when an entry event is detected, the system initializes a new session, and associates the entry event with the new session.

In some embodiments, each event may be associated with an event identifier, and each session may be associated with a session identifier. The data associated with the entry event, such as image captured by the camera, sensing data generated by a gate sensor, and their corresponding timestamps and locations, is stored relationally with an event identifier and session identifier in a database. In some embodiments, the system also determines a first speed and a first direction of the first vehicle as the first vehicle passes the first location, and the first speed and the first direction are also stored as metadata of the first event. In some embodiments, in response to detecting the first event, the system generates a first timestamp, and the first timestamp is also recorded as metadata of the first event.

In some embodiments, one or more vehicle identification models (which are machine learning models) are applied to the captured images to identify the first vehicle. In some embodiments. a first model may be configured to localize the first vehicle on an image, and generate a bounding box around the location of the first vehicle. A second model may be configured to localize a license plate within the bounding box, and generate a second bounding box around the location of the license plate. A third model may be configured to identify features of the vehicle including make, model, color, sticker, among others. A fourth model may be configured to identify the license plate. In some embodiments, one of the third model or the fourth model is sufficient to identify the vehicle. In some embodiments, both models' output are combined to increase the confidence level of the identification of vehicles.

The system receives 440 a second image of a second vehicle captured by a second camera at a second location within a managed facility as the second vehicle traverses a field of view of the second camera. The system associates 450 the second image of the second vehicle with a second event, and applies 460 the vehicle identification model to the second image to determine a second identification of the second vehicle. For example, the second camera may be at an intersection of a path where vehicles may diverge. The second camera may be able to capture the direction of the vehicle is turning.

Similar to the first event, the system may store the second image tagged with an event identifier and the session identifier in a database. For example, the second event may be a left turn event, and the left turn event is associated with its own event identifier, which is in turn associated with the same session identifier. Data associated with the left turn event, such as images captured by the second camera and its corresponding timestamp and location, is stored relationally with its own event identifier and the same session identifier.

The system may also determine a second speed and a second direction of the vehicle as the vehicle passes the second location, and the second speed and the second direction are stored with the second event as metadata. In some embodiments, in response to detecting the second event, the system generates a second timestamp, and the second timestamp is also recorded with the second event as metadata.

The first identification of the first vehicle and the second identification of the second vehicle may or may not be the same. The system determines 470 whether the first identification of the first vehicle and the second identification of the second vehicle are same. Responsive to determining 470 that the first identification and the second identification are same, the system associates 480 the first event and the second event with a same session.

In some embodiments, associating the first event and the second event is further based on the first speed, the first direction, the second speed, and the second direction. In some embodiments, associating the first event and the second event with the same session is further based on the first timestamp and the second timestamp. For example, a first event is associated with a vehicle that enters a managed facility at a speed of 30 mph, heading north, and a second event is associated with the same vehicle at another sensor within the facility moving at a speed at 19 mph, heading south. The timestamps of the two events are within 10 seconds. The system compares the speed and direction from the first and second events. Given that the speeds are different and the direction opposite within an extremely short time range, the system may reassess the determination of the vehicle identifications associated with the two events because the two events are not likely to be associated with the same vehicle.

Additional events associated with the same vehicle identification may be included in the same session, with the final event typically being an exit event that occurs when the same vehicle leaves the managed facility. Unlike an entry event (which triggers the initialization of a new session), the detection of an exit event results in the closure of the session, precluding the association of any further events with that session. The system generates 490 a session timeline of the vehicle based on a sequence of events, including the first event and the second event associated with the same session.

In addition, analyzing the timelines of events in sessions can aid in resolving hanging sessions and hanging events. A hanging session may occur if a vehicle's session remains unresolved for a period exceeding a specified duration (e.g., a day, a week, a month) without a registered exit. This could result from the vehicle exiting the facility without activating the exit sensors due to sensor malfunctions, obstructions, or if the vehicle reverses back through the entry point. A hanging event is an individual record that cannot be accurately linked to a session. It may arise when the vehicle involved is incorrectly identified or not identified at all, or due to errors in identifying the vehicle in other related events.

In some embodiments, the system records all detected events, including hardware events, machine learning events, and matching events, in real time or near real time. The recorded events form an event stream. The event stream not only can be used to generate sessions for tracking vehicles (as describe above with respect to FIG. 4), but also be used to perform other downstream tasks, such as detecting anomalies (e.g., unauthorized access, tailgating, or sensor malfunctions) and identifying patterns in real time or near real time.

For example, within the event stream, there is an entry event that is expected to correspond to a single vehicle passing through a gate. However, if two vehicle detection events are generated in the gate area but the system records only one gate activation event, the combination of these events in the stream may indicate tailgating.

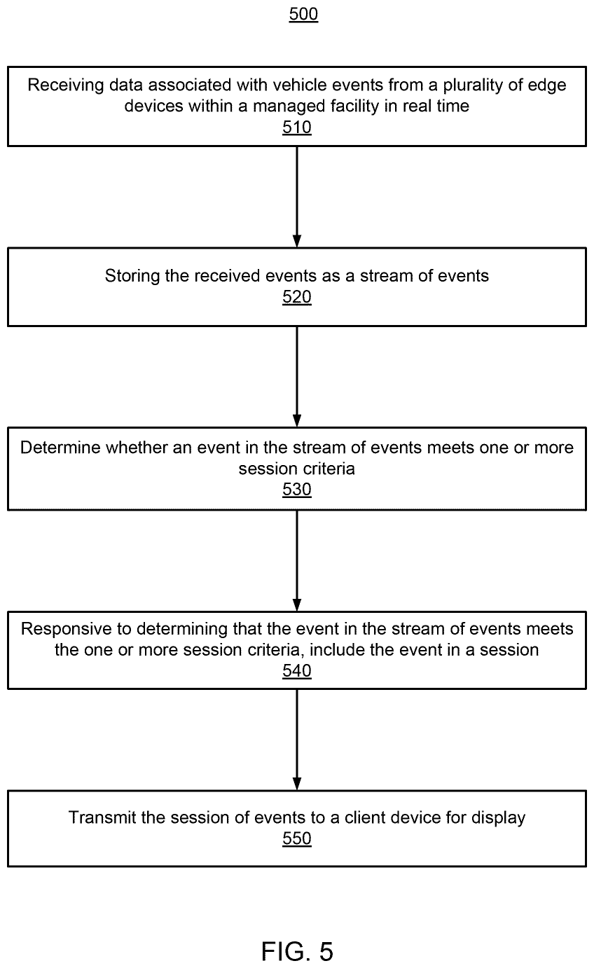

As another example, sessions may be generated based on various criteria. FIG. 5 is a flowchart of an example method for organizing vehicle events detected in a managed facility into sessions in accordance with one or more embodiments. Alternative embodiments may include more, fewer, or different steps from those illustrated in FIG. 5, and the steps may be performed in a different order from that illustrated in FIG. 5. Method 500 may be executed by one or more processors of a system, which may include an edge device 110, a vehicle management server 130, and/or a client device 140. The one or more processors may include processor of edge device 110 and/or of vehicle management server 130 executing instructions that cause one or more modules to perform their respective operations.

The system receives 510 data associated with events from a plurality of edge devices within a managed facility. The plurality of edge devices within the managed facility are hardware devices positioned at different locations within the managed facility to detect, process, and transmit data related to vehicle events. These devices may include or interact with cameras, sensors, gates, and other infrastructure to enable real-time data collection and decision-making. For example, a camera-integrated edge device may include computer vision capabilities to capture and process images or videos of vehicles, and be configured to detect and/or identify vehicle, license plates, make, and/or model of the vehicle. A sensor-integrated edge device may be connected to a proximity sensor, motion sensor, speed sensor, and/or pressure plate. Such a sensor-integrated edge device may be configured to detect events, such as vehicle presence, speed, direction, infractions, such as speeding. A gate controller may be an edge device integrated with a gate at an entry or exit of the managed facility. The gate controller may be configured to detect events associated with the gate or in the gate area, such as vehicle identification, gate open or close, tailgating, etc.

The data associated events received from the edge devices may include metadata related to the events and/or the edge device, such as event timestamp, event location, device identifier, device type, device status, confidence levels of detected events. Event timestamp indicates date and time when an event was detected by the edge device, such that the event can be placed in chronological order. The event location indicates geographic location within the managed facility when an event was detected (e.g., at an entry gate, in a parking zone, or near an exit gate), such that the system can correlate different events based on their locations. A device identifier is a unique identifier or serial number associated with an edge device that transmits the data, such that the event can be traced back to the original device. The confidence levels of detected events indicate a probabilistic value indicating the certainty of the edge device's detection or classification of an event. The system can use the confidence levels in assessing the reliability of detected events and determining whether further validation is required. For example, confidence level of 98% for vehicle recognition indicates high certainty of correct identification, and confidence level of 65% for vehicle identification may trigger further verification by the system.

The system stores 520 the received events as a stream of events. In some embodiments, the system stores organizes and records the received events in a data structure that ensures sequential order and enables efficient retrieval and processing. The stream of events may be a continuous, sequential log of events that are recorded as they occur in real time or near real time, which provides a “digital twin” or “ground truth” of the facility's operation. In some embodiments, events may be appended to the end of a queue as they are detected, and most recent events are at the end of the queue. In some embodiments, events are stored as rows in a database table, with each row representing a single event and columns for event details.

The system determines 530 whether an event in the stream of events meets one or more session criteria. In response to determining that the event in the stream of events meets the one or more session criteria, the system includes 540 the event in a session. The one or more criteria may include predetermined criteria, such as the same vehicle identifier and/or event types. In some embodiments, all events between an entry event and an exit event associated with the same vehicle identifier are included in a single session. In response to detecting a vehicle's entry event, the system generates a new session and includes the entry event in the new session. Furthermore, in response to detecting subsequent events associated with the same vehicle within the managed facility, these subsequent events are also included in the same session until an exit event is detected. In response to detecting an exit event, the system includes the exit event in the session and closes the session. If the vehicle reenters the managed facility, a new session is generated. Additionally, when determining whether an additional event should be included in the session, the system can analyze the event's timestamp, location data, and event type to logically determine whether the additional event should be part of the session. This analysis enables the system to confirm low-confidence score events based on contextual information.

Note, this is merely an example use case of a session. In some embodiments, other criteria can be used to generate sessions with or without vehicle identification. For example, a session may be generated based on time frames surrounding specific events, such as an infraction event. In some embodiments, in response to detecting an infraction event, a session is generated to include events occurring before and after the infraction event within a predetermined timeframe, ensuring that other events associated with the infringing vehicle are likely included in the session.

In some embodiments, sessions can be generated in response to queries. For example, a user (who may be a facility manager or a driver) may enter a query with one or more specific criteria. The system may analyze the event data in the stream of events to group relevant events into a session based on the criteria specified in the query. For instance, a query may specify a start time, an end time, and a specific zone within the managed facility. In response to the query, the system identifies all events detected during the timeframe between the start and end time and within the specified zone of the managed facility and generates a session including all the identified events.

The system transmits 550 the session of events to a client device for display. For example, for a session associated with a specific vehicle, the sessions may be stored with a user account (associated with the specific vehicle). The user is able to access the data describing the events via a mobile application or a browser. As another example, an infraction session may be transmitted to a client device associated with a facility manager for review and/or a client device associated with a driver of the vehicle, providing remediation solutions.

### Example Managed Facility

FIGS. 6A-C depict embodiments of an exemplary managed facility and moveable gate. As depicted in FIG. 6A, a managed facility 600 includes a set of parking spaces 602 within which vehicles 605 (e.g., cars) may park. Managed facility 600 includes sensors, such as parking sensors 615 and cameras 112. Parking sensors 615 may be located within parking spaces 602 to detect when vehicles 605 are present. As depicted on the left-hand side of managed facility 600, managed facility 600 includes gates 114. The bottom gate 114 allows vehicles 605 to enter managed facility 600 from street 620 through an entry lane 640 and the top gate 114 allows vehicles 605 to exit managed facility 600 through an exit lane 635.

The gate sensor, parking sensors 615, and cameras 112 are configured to detect events and generating sensing data, including images captured by cameras 112. Metadata associated with timestamps of the events and locations of the sensor 615 or camera 112 are also stored with the sensing data and images and transmitted to the vehicle management server 130 via network 120.

Managed facility 600 may include a pedestrian door 610, allowing pedestrians to enter from, for example, a sidewalk 630. The pedestrian door may be locked and RFID enabled such that users may enter through the pedestrian door responsive to edge device 110 receiving, from the user, a set of user credentials. Example user credentials may include user personal information, contact information, account information, and vehicle information (e.g., make, model, color, license plate).

FIG. 6A also depicts an infracting vehicle 606. Edge device 110 may, through infraction detection module 240, determine that vehicle 606 is an infracting vehicle due to the way vehicle 606 is parked, where the vehicle is talking up two parking spots 602 instead of one parking spot 602. Responsive to detecting the infraction, edge device 110 may trigger a remediation action that allocates for the use of the multiple parking spaces. Responsive to detecting some infractions, edge device 110 may trigger remediation actions that deploy an exit blocking device (e.g., gate 114) that prevents movement of vehicle 605 (or 606) out from managed facility 600.

The cameras 112 are positioned at various locations within the management facility. Each camera 112 or other sensors coupled to the camera 112 may be able to detect a moving direction of a vehicle, e.g., approaching the camera 112 or away from the camera. Based on the moving direction of the vehicle, the system may detect different events, such as an approaching event and an away event.

FIGS. 6B and 6C depict embodiments of managed facility 600 in which a two-gate system is implemented in entry lane 640. The two-gate system includes a first gate 16 with cameras 112 pointed towards it and a second gate 115. Between the first gate 16 and the second gate 115 is a secondary zone 645. The secondary zone 645 includes access to the exit lane 635 (e.g., via crossing the dashed line). FIG. 6B shows operation of the two-gate system responsive to a non-infracting vehicle (e.g., vehicle 605) attempting to enter the managed facility. In FIG. 6B, responsive to detecting vehicle 605 at the first gate 16, edge device 110 may open the first gate 16, allowing vehicle 605 to pass into a secondary zone 645. While in the secondary zone 645, cameras 112 may take images of vehicle 605. Responsive to determining (e.g., through entry monitoring module 226) that vehicle 605 is not an infracting vehicle, edge device 110 may open the second gate 115, allowing vehicle 605 to enter managed facility 600. FIG. 6C shows operation of the two-gate system responsive to an infracting vehicle (e.g., vehicle 606) attempting to enter the managed facility. In FIG. 6C, responsive to detecting infracting vehicle 606 at the first gate 16, edge device 110 may open the first gate 16, allowing infracting vehicle 606 to pass into a secondary zone 645. While in the secondary zone 645, cameras 112 may take images of infracting vehicle 606. Responsive to determining (e.g., through entry monitoring module 226) that vehicle 606 is an infracting vehicle, instead of opening the second gate 115 as edge device 110 did for vehicle 605, edge device 110 may trigger a remediation action. For example, as a remediation action, edge device 110 may provide, for display at the second gate 115, a message to a user of infracting vehicle 606 asking the user to route infracting vehicle 606 into exit lane 635.

The aforementioned managed facility could be a parking facility that tags both entry and exit events for vehicles. However, different types of managed facilities might record a single tagged event or multiple tagged events per vehicle. For instance, a carwash facility might only tag a vehicle's entry into the wash area. Conversely, a drive-through restaurant could tag multiple events: one when a driver of the vehicle stops at a location for placing an order and another when the ordered items are handed over to the vehicle, completing the transaction. Additionally, an automated toll might tag just an entry or both an entry and exit event. In facilities that track multiple tagged events, vehicle misidentifications might be identified through unresolved (“hanging”) events. In contrast, facilities that record a single tagged event might detect misidentifications by comparing features between captured images of vehicles and registered vehicles within the system. Responsive to determining a misidentification of a vehicle, corrections can be made either manually or automatically, in a manner similar to that described above. For single tagged event scenarios, the correction data may be obtained without reference to another event. This correction data can also be used to generate additional training examples for retraining the machine-learning model for vehicle identification, continuously enhancing the accuracy of the machine-learning model through human-in-the-loop driven or automated retraining.

### Example Computer System

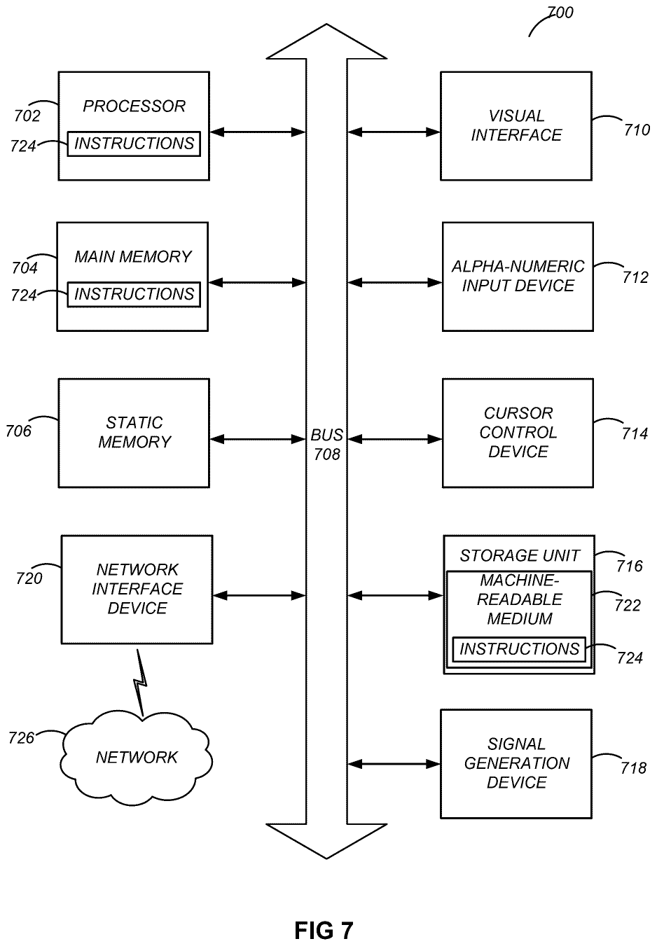

FIG. 7 is a block diagram illustrating components of an example machine able to read instructions from a machine-readable medium and execute them in a processor (or controller). FIG. 7 is a block diagram illustrating components of an example machine able to read instructions from a machine-readable medium and execute them in a processor (or controller). Specifically, FIG. 7 shows a diagrammatic representation of a machine in the example form of a computer system 700 within which program code (e.g., software) for causing the machine to perform any one or more of the methodologies discussed herein may be executed. The program code may be comprised of instructions 724 executable by one or more processors 702. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a computing system capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processors 702 (e.g., a central processing unit (CPU), a graphics processing unit (GPU), a digital signal processor (DSP), one or more application specific integrated circuits (ASICs), one or more radio-frequency integrated circuits (RFICs), field programmable gate arrays (FPGAs)), a main memory 704, and a static memory 706, which are configured to communicate with each other via a bus 708. The computer system 700 may further include visual display interface 710. The visual interface may include a software driver that enables (or provide) user interfaces to render on a screen either directly or indirectly. The visual interface 710 may interface with a touch enabled screen. The computer system 700 may also include input devices 712 (e.g., a keyboard a mouse), a cursor control device 714, a storage unit 716, a signal generation device 718 (e.g., a microphone and/or speaker), and a network interface device 720, which also are configured to communicate via the bus 708.

The storage unit 716 includes a machine-readable medium 722 (e.g., magnetic disk or solid-state memory) on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution.

### Additional Configuration Considerations

The embodiments described herein improve the accuracy and efficiency of vehicle tracking systems in managed facilities. By associating multiple related events with specific sessions rather than treating them as isolated occurrences, the system significantly enhances the ability to identify vehicles and track the entire trajectory of a vehicle within a facility. The session-based approach allows for a more accurate correlation of vehicle movements, which is effective in maintaining accurate counts, ensuring compliance with facility regulations, and enhancing security by minimizing untracked vehicles and hanging events-where vehicles remain unlogged due to system errors or anomalies. This not only reduces the likelihood of operational disruptions but also decreases the risk of security breaches related to unmonitored vehicles entries and exits.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium and processor executable) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process for seamless entry and exit to a managed facility blocked by a moveable gate through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for tracking vehicle sessions in managed facilities, comprising:
receiving a first image of a vehicle captured by a first camera at a first location within a managed facility as the vehicle traverses a field of view of the first camera;
determining a first direction of the first vehicle as the first vehicle passes the first location;
associating the first image of the vehicle with a first event and storing the first direction as metadata of the first event;
applying a vehicle identification model to the first image to determine a first identification of the vehicle;
receiving a second image of the vehicle captured by a second camera at a second location within a managed facility as the vehicle traverses a field of view of the second camera;
determining a second direction of the vehicle as the vehicle passes the second location;
associating the second image of the vehicle with a second event and storing the second direction as metadata of the second event;
applying the vehicle identification model to the second image to determine a second identification of the vehicle;
determining that the first event and the second event are part of a same session based at least on a concordance of the first identification, the second identification, the first direction, and the second direction, wherein the second identification matches the first identification;
responsive to determining that the first event and the second event are part of the same session, associating the first event and the second event with the same session; and
determining a session timeline of the vehicle based on a sequence of events, including the first event and the second event associated with the same session.

2. The method of claim 1, further comprising:
storing the first image and the second image in a data repository, wherein each of the first image and second image is tagged with a respective event identifier and a session identifier.

3. The method of claim 1, further comprising:
determining a first speed of the first vehicle as the first vehicle passes the first location;
storing the first speed and as part of the metadata of the first event;
determining a second speed of the vehicle as the vehicle passes the second location; and
storing the second speed as part of the metadata of the second event,
wherein associating the first event and the second event is further based on the first speed and the second speed.

4. The method of claim 1, further comprising:
in response to detecting the first event, generating a first timestamp;
recording the first timestamp as metadata of the first event;
in response to detecting the second event, generating a second timestamp; and
recording the second timestamp as metadata of the second event,
wherein associating the first event and the second event with the same session is further based on the first timestamp and the second timestamp.

5. The method of claim 1, wherein the first camera is located in a first zone of the managed facility, and the second camera is located in a second zone of the managed facility, and
wherein the method further comprises determining a duration of the vehicle in each of the first zone and the second zone.

6. The method of claim 1, wherein in the session, an event that occurs first is an entry event in which the vehicle enters a gate of the managed facility, and an event that occurs last is an exit event in which the vehicle exits a gate of the managed facility.

7. The method of claim 6, further comprising:
responsive to determining that the first event is the entry event, initializing a new session for the vehicle; and
associating the first event with the new session.

8. The method of claim 6, further comprising:
responsive to determining that the second event is an exit event, closing the session for the vehicle, such that no new event can be associated with the session.

9. The method of claim 8, further comprising:
determining that the session remains open for more than a threshold amount of time;
identifying a hanging event that cannot be associated with any existing vehicle session;
comparing images associated with the hanging session and images associated with the hanging event to determine a similarity score; and
responsive to determining that the similarity score is greater than a predetermined threshold, associating the hanging event with the hanging session.

10. The method of claim 1, further comprising:
receiving a query including one or more criteria associated with events;
identifying a set of events that satisfy the one or more criteria; and
generating a session and associating the set of events with the session.

11. A non-transitory computer-readable medium comprising memory with instructions encoded thereon, the instructions comprising instructions to cause one or more processors to perform steps comprising:
receiving a first image of a vehicle captured by a first camera at a first location within a managed facility as the vehicle traverses a field of view of the first camera;
determining a first direction of the first vehicle as the first vehicle passes the first location;
associating the first image of the vehicle with a first event and storing the first direction as metadata of the first event;
applying a vehicle identification model to the first image to determine a first identification of the vehicle;
receiving a second image of the vehicle captured by a second camera at a second location within a managed facility as the vehicle traverses a field of view of the second camera;
determining a second direction of the vehicle as the vehicle passes the second location;
associating the second image of the vehicle with a second event and storing the second direction as metadata of the second event;
applying the vehicle identification model to the second image to determine a second identification of the vehicle;
determining that the first event and the second event are part of a same session based at least on a concordance of the first identification, the second identification, the first direction, and the second direction wherein, the second identification matches the first identification;
responsive to determining that the first event and the second event are part of the same session, associating the first event and the second event with the same session; and
determining a session timeline of the vehicle based on a sequence of events, including the first event and the second event associated with the same session.

12. The non-transitory computer-readable medium of claim 11, the steps further comprising:
determining a first speed of the first vehicle as the first vehicle passes the first location;
storing the first speed and as part of the metadata of the first event;
determining a second speed of the vehicle as the vehicle passes the second location; and
storing the second speed as part of the metadata of the second event,
wherein associating the first event and the second event is further based on the first speed and the second speed.

13. The non-transitory computer-readable medium of claim 11, the steps further comprising:
in response to detecting the first event, generating a first timestamp;
recording the first timestamp as metadata of the first event;
in response to detecting the second event, generating a second timestamp; and
recording the second timestamp as metadata of the second event,
wherein associating the first event and the second event with the same session is further based on the first timestamp and the second timestamp.

14. The non-transitory computer-readable medium of claim 11, wherein the first camera is located in a first zone of the managed facility, and the second camera is located in a second zone of the managed facility, and
wherein the steps further comprises determining a duration of the vehicle in each of the first zone and the second zone.

15. The non-transitory computer-readable medium of claim 11, wherein in the session, an event that occurs first is an entry event in which the vehicle enters a gate of the managed facility, and an event that occurs last is an exit event in which the vehicle exits a gate of the managed facility.

16. The non-transitory computer-readable medium of claim 15, the steps further comprising:
responsive to determining that the first event is the entry event, initializing a new session for the vehicle; and
associating the first event with the new session.

17. The non-transitory computer-readable medium of claim 15, the steps further comprising:
responsive to determining that the second event is an exit event, closing the session for the vehicle, such that no new event can be associated with the session.

18. The non-transitory computer-readable medium of claim 17, the steps further comprising:
determining that the session remains open for more than a threshold amount of time;
identifying a hanging event that cannot be associated with any existing vehicle session;
comparing images associated with the hanging session and images associated with the hanging event to determine a similarity score; and
responsive to determining that the similarity score is greater than a predetermined threshold, associating the hanging event with the hanging session.

19. The non-transitory computer-readable medium of claim 18, the steps further comprising:
receiving a query including one or more criteria associated with events;
identifying a set of events that satisfy the one or more criteria; and
generating a session and associating the set of events with the session.

20. A system comprising:
memory with instructions encoded thereon; and
one or more processors that, when executing the instructions, are caused to perform operations comprising:
receiving a first image of a vehicle captured by a first camera at a first location within a managed facility as the vehicle traverses a field of view of the first camera;
determining a first direction of the first vehicle as the first vehicle passes the first location;
associating the first image of the vehicle with a first event and storing the first direction as metadata of the first event;
applying a vehicle identification model to the first image to determine a first identification of the vehicle;
receiving a second image of the vehicle captured by a second camera at a second location within a managed facility as the vehicle traverses a field of view of the second camera;
determining a second direction of the vehicle as the vehicle passes the second location;
associating the second image of the vehicle with a second event and storing the second direction as metadata of the second event;
applying the vehicle identification model to the second image to determine a second identification of the vehicle;
determining that the first event and the second event are part of a same session based at least on a concordance of the first identification, the second identification, the first direction, and the second direction, wherein the second identification matches the first identification;
responsive to determining that the first event and the second event are part of the same session, associating the first event and the second event with the same session; and
determining a session timeline of the vehicle based on a sequence of events, including the first event and the second event associated with the same session.
